(19) United States
(12) Patent Application Publication
(10) Pub. No.: US 2017/0279587 A1
(43) Pub. Date: Sep. 28, 2017

(54) METHOD OF SOUNDING USING MANIPULATED NULL DATA PACKETS (NDP)

(71) Applicants: Chittabrata Ghosh, Fremont, CA (US); Avi Mansour, Haifa (IL); Yaron Alpert, Hod Hasharoni (IL); Ziv Avital, Haifa (IL)

(72) Inventors: Chittabrata Ghosh, Fremont, CA (US); Avi Mansour, Haifa (IL); Yaron Alpert, Hod Hasharoni (IL); Ziv Avital, Haifa (IL)

(21) Appl. No.: 15/077,337

(22) Filed: Mar. 22, 2016

(51) Int. Cl. H04L 5/00; H04W 84/12; H04B 7/06

(52) U.S. Cl. CPC H04L 5/0094; H04B 7/0617; H04W 84/12

(57) ABSTRACT

Apparatuses, methods, and computer readable media are disclosed for sounding using manipulated null data packets (NDP). An apparatus of an wireless device comprising memory and processing circuitry coupled to the memory is disclosed. The processing circuitry may be configured to: encode a null data packet (NDP) announcement (NDP-A) frame, configure the wireless device to transmit the NDP-A frame, and encode a manipulated NDP frame. The processing circuitry may be further configured to configure the wireless device to transmit the manipulated NDP frame, encode a trigger frame comprising resource allocations for one or more stations, and configure the wireless device to transmit the trigger frame. The processing circuitry may decode beamforming feedback frames from the stations, where the beamforming feedback frames are to he received by the wireless device in accordance with the resource allocations, and where the beamforming feedback frames are to comprise feedback for the manipulated NDP frame.

### TECHNICAL FIELD

Embodiments relate to wireless devices. Some embodiments relate to Institute of Electrical and Electronic Engineers (IEEE) 802.11. Some embodiments relate to high-efficiency wireless local-area networks (HEWs). Some embodiments relate to long-range low-power (LRLP) wireless devices. Some embodiments relate to IEEE 802.11ax. Some embodiments relate to apparatuses, computer readable media, and methods of sounding using manipulated null data packets (NDP).

### BACKGROUND

Efficient use of the resources of a wireless local-area network (WLAN) is important to provide bandwidth and acceptable response times to the users of the WLAN. Moreover, wireless devices may need to operate with both newer protocols and with legacy device protocols. Some wireless devices may operate with limited power and may have limited functionality. Moreover, there may be many limited power and/or limited functionality wireless devices.

Thus, there are general needs for methods, apparatuses, and computer readable media for location based query for low power devices.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a wireless network in accordance with some embodiments;

FIG. 2. illustrates a method of sounding using manipulated null data packets (NDP) in accordance with some embodiments;

FIG. 3 illustrates an example manipulated null data packet (M-NDP) 300 in accordance with some embodiments;

FIG. 4 illustrates a method of sounding using manipulated NDP in accordance with some embodiments;

FIG, 5 illustrates a method of sounding using manipulated NDP in accordance with some embodiments; and

FIG. 6 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

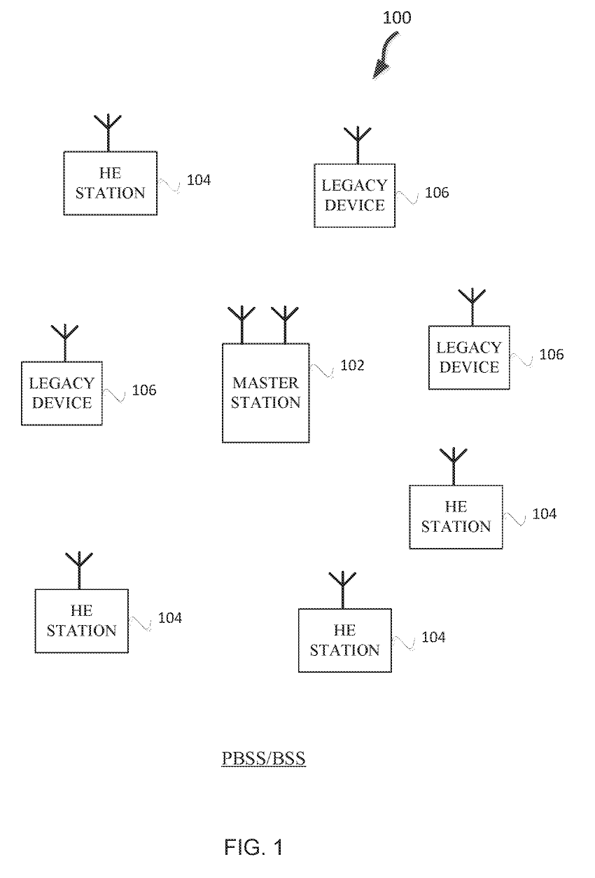

FIG. 1 illustrates a WLAN 100 in accordance with some embodiments. The WLAN may comprise a basis service set (BSS) 100 that may include a master station 102, which may be an AP, a plurality of high-efficiency wireless (e.g., IEEE 802.11ax) (HE) stations 104, and a plurality of legacy (e.g., IEEE 802.11n/ac) devices 106. The HE stations 104 may be LRLP stations.

The master station 102 may be an AP using the IEEE 802.11 to transmit and receive. The master station 102 may be a base station. The master station 102 may use other communications protocols as well as the IEEE 802.11 protocol. The IEEE 802.11 protocol may be IEEE 802.11ax and/or LRLP. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one master station 102 that is part of a extended service set (ESS). A controller may store information that is common to the more than one master stations 102.

The legacy devices 106 may operate in accordance with one or more of IEEE 802.11 a/b/g/n/ac/ad/af/ah/aj/ay, or another legacy wireless communication standard. The legacy devices 106 may be STAs or IEEE STAs. The HE STAs 104 may be wireless transmit and receive devices such as cellular telephone, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HE STAs 104 may be termed high efficiency (HE) stations.

The master station 102 may communicate with legacy devices 106 in accordance with legacy IEEE 802.11 communication techniques. In example embodiments, the master station 102 may also be configured to communicate with HE STAs 104 in accordance with legacy IEEE 802.11 communication techniques.

In some embodiments, a HE frame may be configurable to have the same bandwidth as a subchannel. The bandwidth of a subchannel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a subchannel may be 1 MHz, 1.25 MHz, 2.03 MHz, 2.5 MHz, 5 MHz and 10 MHz, or a combination thereof or another bandwidth that is less or equal to the available bandwidth may also be used. In some embodiments the bandwidth of the subchannels may be based on a number of active subcarriers. In some embodiments the bandwidth of the subchannels are 26, 52, 104, 242, etc. active data subcarriers or tones that are spaced by 20 MHz. In some embodiments the bandwidth of the subchannels is 256 tones spaced by 20 MHz. In some embodiments the subchannels are multiple of 26 tones or a multiple of 20 MHz. In some embodiments a 20 MHz subchannel may comprise 256 tones for a 256 point Fast Fourier Transform (FFT).

A HE frame may be configured for transmitting a number of spatial streams, which may be in accordance with MU-MIMO. In other embodiments, the master station 102, HE STA 104, and/or legacy device 106 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®, or other technologies.

Some embodiments relate to HE and/or LRLP communications. In accordance with some IEEE 802.11ax and/or LRLP embodiments, a master station 102 may operate as a master station which may be arranged to contend for a wireless medium (e.g., during a contention period) to receive exclusive control of the medium for an HE and/or LRLP control period. In some embodiments, the HE and/or LRLP control period may be termed a transmission opportunity (TXOP). The master station 102 may transmit a HE master-sync transmission, which may be a trigger frame or HE control and schedule transmission, at the beginning of the HE control period. The master station 102 may transmit a time duration of the TXOP and sub-channel information. During the HE control period, HE STAs 104 may communicate with the master station 102 in accordance with a non-contention based multiple access technique such as OFDMA or MU-MIMO. This is unlike conventional WLAN communications in which devices communicate in accordance with a contention-based communication technique, rather than a multiple access technique. During the HE control period, the master station 102 may communicate with HE stations 104 using one or more HE frames, During the HE control period, the HE STAs 104 may operate on a sub-channel smaller than the operating range of the master station 102. During the HE control period, legacy stations refrain from communicating.

In accordance with some embodiments, during the master-sync transmission the HE STAs 104 may contend for the wireless medium with the legacy devices 106 being excluded from contending for the wireless medium during the master-sync transmission. In some embodiments the trigger frame may indicate one or both of an uplink (UL) UL-MU-MIMO or UL OFDMA control period.

In some embodiments, the multiple-access technique used during the HE control period may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station 102 may also communicate with legacy stations 106 and/or HE stations 104 in accordance with legacy IEEE 802.11 communication techniques. In some embodiments, the master station 102 may also be configurable to communicate with HE stations 104 outside the HE control period in accordance with legacy IEEE 802.11 communication techniques, although this is not a requirement.

In example embodiments, the HE device 104 and/or the master station 102 are configured to perform the methods and functions herein described in conjunction with FIGS. 1-6.

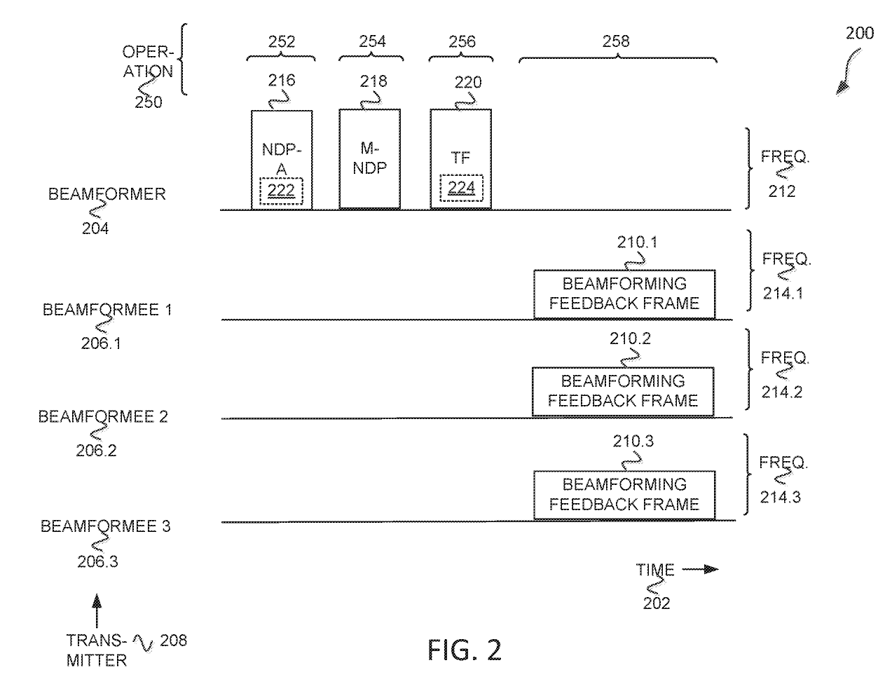

FIG. 2. illustrates a method 200 of sounding using manipulated null data packets (NDP) in accordance with some embodiments. Illustrated in FIG. 2 is time 202 along a horizontal axis, frequency 212, 214 along a vertical axis, transmitters 208, and operation 250 along the top. The beamformer 204 may be a master station 102, HE station 104, and/or legacy station 108. Beamformee 1 206.1, beamformee 2 206.2, and beamformee 3 206.3 may be HE stations 104, legacy stations 106, and/or master stations 102. The beamformees 206 may receive a physical layer (PHY) protocol data unit (PPDU) that was transmitted using a beamforming steering matrix. For example, the M-NDP 218 may be received by the beamformees 206. The beamformer 204 may transmit a physical layer using a beamforming steering matrix. For example, M-NDP 218 may be a PPDU transmitted using a beamforming steering matrix.

The method 200 begins at operation 252 with a beamformer 204 transmitting null data packet announcement (NDP-A) 216 on channel 212. The NDP-A 216 may not have a data field in the physical layer payload. The NDP-A 216 may include identifications of beamformees 206 and may include a duration for other stations to defer until the end of the method 200. The beamformer 204 may transmit the NDP-A 216 on a frequency 212 that is a primary channel, e.g. a 20 MHz channel. The NDP-A 216 may include a modified NDP (M-NDP) format 222 of the M-NDP 218.

The M-NDP format 222 may indicate one or more of the following a number of manipulated portions or sounding elements 316 of the M-NDP 218, and for each sounding element of the M-NDP 218 one or more of the following manipulations that may be indicated: beamforming or no beamforming; a beamforming type; a number of active transmit chains; a duration of the symbols (e.g. 1 times duration, 2 times duration, or 4 times duration of a legacy duration of 3.2 μs); a transmit power; a modulation and coding scheme; a bandwidth; and, a flavor of sounding procedure.

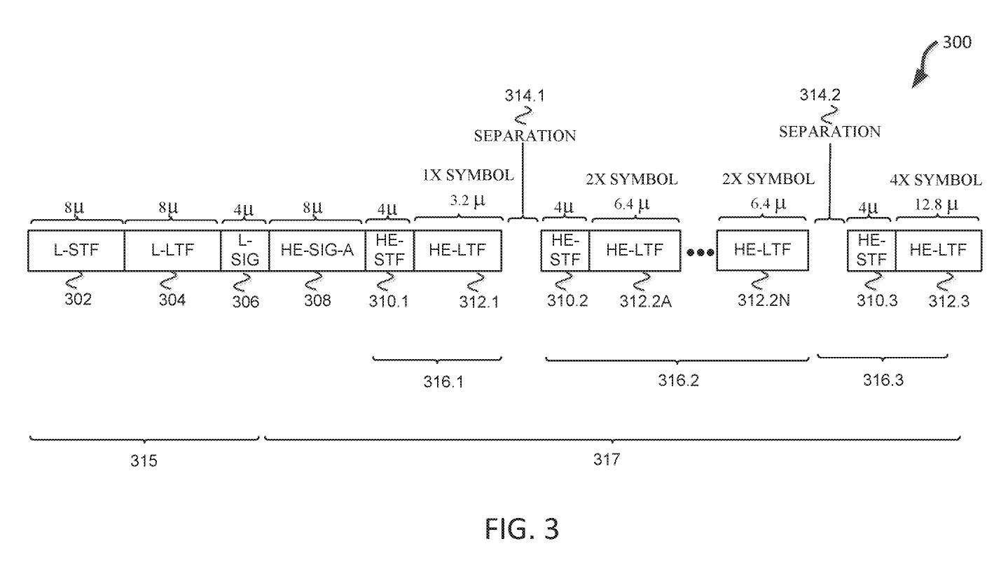

An example, M-NDP 218 is described in conjunction with FIG. 3. The M-NDP format 222 may indicate a type of report that the beamformees 206 are to generate and transmit back to the beamformer 204. For example, the type of report may be for a feedback matrix or an indication of signal-to-noise ratio. The type of report may be for each of the sounding elements or manipulated portions 316.

The method 200 may continue at operation 254 with the beamformer 204 transmitting a M-NDP 218, The M-NDP 218 may be a null data packet with one or more manipulated portions or sounding elements (e.g., 316.1, 316.2, 316.3 of FIG. 3). Each of the one or more manipulated portions or sounding elements of the M-NDP 218 may be manipulated by one or more of the manipulations disclosed above. For example, the one or more manipulated portions or sounding elements of the M-NDP 218 may be sent using beamforming with two or more antennas (with an associated steering matrix), or portions of the M-NDP 218 may be transmitted with no beamforming. The one or more manipulated portions or sounding elements of the M-NDP 218 may use one or more active transmit chains. Portions of the M-NDP 218 may be transmitted with different active chains.

For example, portions of the M-NDP 218 may be transmitted using MU-MIMO with four or eight antennas. Portions of the M-NDP 218 may be transmitted with a symbol duration of one times, two times, four times, or another multiple of the symbol duration of legacy communication standard. For example, portions of the M-NDP 218 may be transmitted with a symbol duration of 3.2 μs, 6.4 μs, or 12.8 μs. Portions of the M-NDP 218 may be transmitted with a different power levels than other portions of the M-NDP 218. Portions of the M-NDP 218 may be transmitted with different MCSs.

In some embodiments, the NDP-A 216 may act as the TF 220. For example, the NDP-A may include a resource allocation 224 for the beamformees 206 to transmit the beamforming feedback frames 210.

FIG. 3 is disclosed in conjunction with FIG. 2. FIG. 3 illustrates an example of a manipulated null data packet (M-NDP) 300 in accordance with some embodiments. FIG. 3 illustrates a M-NDP 300 that comprises a preamble format 315 and manipulated portion 317. The preamble format 315 includes a legacy short-training field (L-STF) 302, a legacy long-training field (L-LTF) 304, and a legacy signal field (L-SIG) 306. The preamble format 315 may be different. The preamble format 315 may signal that the manipulated portion 317 is a HE format. The preamble format 315 may indicate that the manipulated portion 317 is a HE manipulated portion.

The manipulated portion 317 may include a high-efficiency (HE) signal field A (HE-SIG-A) 30, and one or more manipulated portions or sounding elements 316.1, 316.2, 316.3. HE-SIG 308, HE-STF 310, and HE-LTF 312 are indicated, but the fields may be different fields. For example, the fields may be different for IEEE 802.11ax (e.g., the HE-STF 310 and HE-LTF 312 may be different for IEEE 802.11ax). In some embodiments, the one or more manipulated portions may be termed one or more sounding elements.

The L-STF 302 may be in accordance with communication standard Institute of Electrical and Electronic Engineers (IEEE) 802.11a and may have a duration of 8 μs. The L-LFT 304 may be in accordance with communication standard IEEE 802.11a and may have a duration of 8 μs. The L-SIG 306 may be in accordance with communication standard IEEE 802.11a and may be transmitted using binary phase shift keying (BPSK) with a coding rate of one half and may have a duration of 4 μs. The HE-SIG-A 308 may indicate attributes of the manipulated portions or sounding elements 316 such as the bandwidth of the channel, MCS used, symbol duration, transmit power, beamforming type, and whether the frame is a single or multi-user frame. The HE-SIG-A 308 may indicate how one or more of the manipulated portions or sounding elements 316 are manipulated as described herein. Additionally, the HE-SIG-A 308 may indicate the duration of the separation 314. In some embodiments, the HE-SIG-A 308 may be transmitted with a symbol duration of four times a legacy duration of 3.2 μs.

There are three manipulated portions or sounding elements 316 as illustrated. In sonic embodiments there is one manipulated portion or sounding element 316. In some embodiments there are two manipulated portions or sounding elements 316 or greater than three manipulated portions or sounding elements 316. Each manipulated portion or sounding element 316 comprises one or more very-high throughput short-training field (HE-STF) 310 and one or more very-high throughput long-training field (HE-LTF) 312. For example, manipulated portion or sounding element 316.1 includes one HE-LTF 312.1, and manipulated portion or sounding element 316.2 includes N HE-LTFs, HE-LTF 312.2A through HE-LTF 312.2N. In some embodiments, the manipulated portion 317 does not include HE-SIG-A 308.

Each manipulated portion or sounding element 316 may be manipulated differently than other manipulated portions or sounding elements 316. Each manipulated portion or sounding element 316 may be manipulated as described herein.

There may be n manipulated portions or sounding elements 316. There may be a separation 314 between the manipulated portions or sounding elements 316. The separation 314 may be a pre-defined separation between the manipulated portions or sounding elements 316, e.g., a short inter-frame separation (SIFS), or zero separation.

Returning to the method 200, the method 200 continues at operation 256 with the beamformer 204 transmitting a trigger frame 220. The TF 220 may include resource allocations 224 for the beamformees 206 to transmit the beamforming feedback frames 210. The resource allocation 224 may indicate that the beamforming feedback frames 210 may be transmitted simultaneously or sequentially. The resource allocation 224 may indicate an order for the beamformees 206 to transmit their beamforming feedback frames 210. The resource allocation 224 may indicate that the beamformees 206 are to transmit the beamforming feedback frames 210 in multiple simultaneous UL data transmissions. The resource allocation 224 may indicate one or both of OFDMA and MU-MIMO. The resource allocations 224 may include an indication of a type of report the beamformees 206 should generate. In some embodiments, the trigger frame 220 may not be transmitted. The resource allocations 224 may be part of the NDP-A 216 or the resource allocation may be implied by, for example, an order of the beamformees 206 in the NDP-A 216. In some embodiments, the TF 220 may be transmitted before the M-NDP 218.

The method 200 may continue at operation 258 with the beamformee 1 206.1, beamformee 2 206.2, and beamformee 3 206,3, transmitting beamforming feedback frame 210.1, beamforming feedback frame 210.2, and beamforming feedback frame 210.3, respectively.

The beamformees 206 may transmit the beamforming feedback frames 210 in accordance with the resource allocations 224. The beamformees 206 may generate the beamforming feedback frames 210 based on analyzing the manipulated portions or sounding elements 316 of the M-NDP 218. The beamformees 206 may generate the beamforming feedback based on the M-NDP format 222. For example, the M-NDP format 222 may indicate the feedback should be a steering matrix or a signal-to-noise ratio. The beamformees 206 may calculate one or more feedback matrixes or steering matrixes for each manipulated portion or sounding element 316 of the M-NDP 218. In some embodiments, where multiple M-NDP 218 are transmitted, the beamformees 206 may calculate one or more feedback matrixes or steering matrixes for each of the M-NDPs 218. The feedback of the beamforming feedback frames 210 may be channel sounding information (CSI). The beamformees 206 may transmit the beamforming feedback frames 210 consecutively rather than simultaneously.

In some embodiments, the method 200 may continue with the beamformer 204 transmitting a second TF 220 for additional beamformees 206 (not illustrated.) The additional TFs 220 may enable the beamformer 204 to perform beamforming with more beamformees 206 than there are channels for responses to send the beamforming feedback frames 210. In some embodiments, the method 200 may continue with the beamformer 204 determining a channel to transmit to at least one of the beamformees 206 based on the beamforming feedback frames 210.

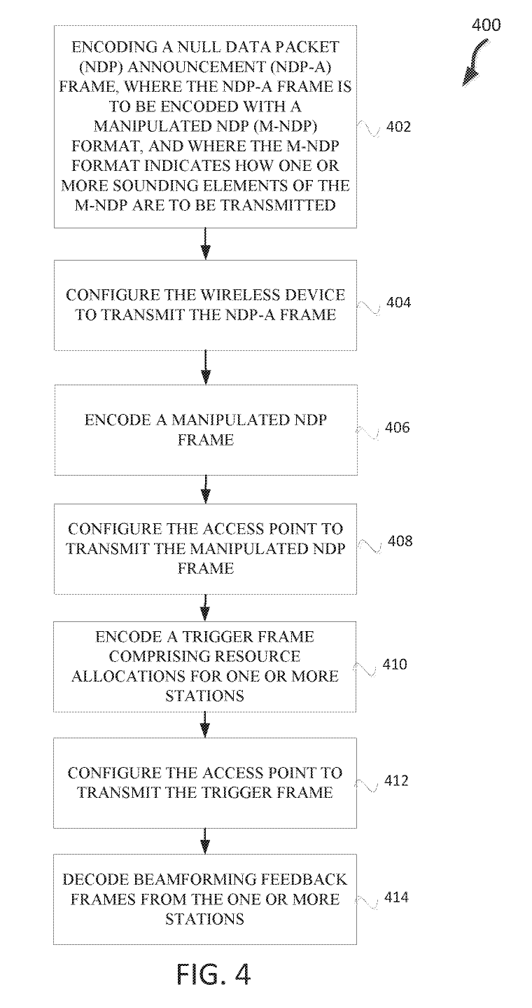

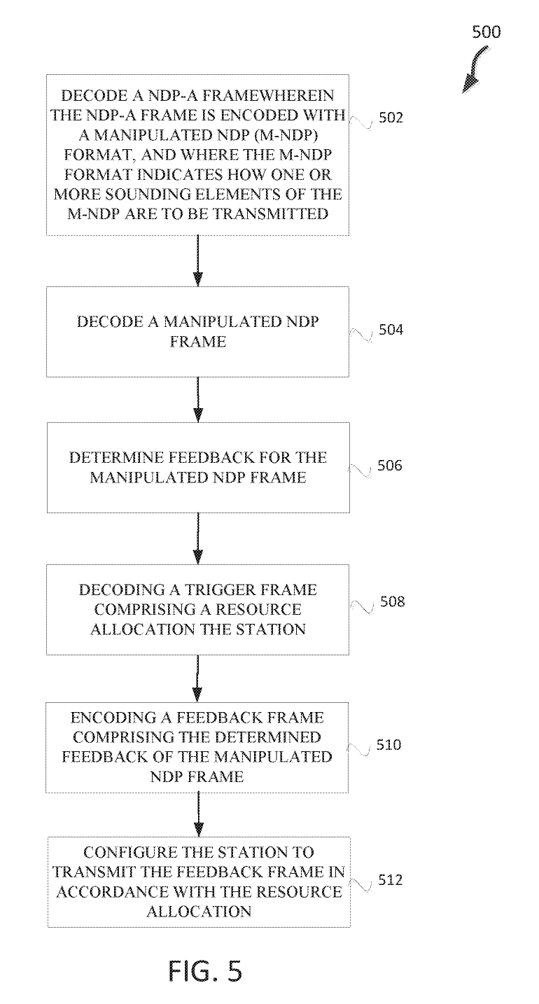

FIG. 4 illustrates a method 400 of sounding using manipulated NDP in accordance with some embodiments. The method 400 may begin at operation 402 with encoding a null data packet (NDP) announcement (NDP-A) frame, where the NDP-A frame is to be encoded with a manipulated NDP (M-NDP) format, and where the M-NDP format indicates how one or more sounding elements of the M-NDP are to be transmitted. The sounding elements may be termed manipulated portions. For example, referring to FIG. 2, an apparatus of the beamformer 204 may encode the NDP-A 216 prior to transmitting the NDP-A 216. The NDP-A 216 may include a M-NDP format 222 of the M-NDP 218. The apparatus may be a portion of the example machine 600 that enables the functionality of method 400.

The method 400 continues at operation 404 with configuring the wireless device to transmit the NDP-A frame. For example, referring to FIG. 2, an apparatus of the beamformer 204 may configure the beamformer 204 to transmit the NDP-A 216.

The method 400 continues at operation 406 with encoding a manipulated NDP frame. For example, an apparatus of the beamformer 204 may encode the M-NDP frame. The M-NDP frame may be the M-NDP frame 300 with one or more manipulated portions or sounding elements 316. The M-NDP frame may be encoded in accordance with a M-NDP format (e.g., M-NDP format of FIG. 2). The manipulated portion 317 may include one or more manipulated portions or sounding elements 316.1, 316.2, 316.3.

The method 400 continues at operation 408 with configuring the access point to transmit the manipulated NDP frame, For example, an apparatus of the beamformer 204 may configure the beamformer 204 to transmit the M-NDP 218. For example, the apparatus of the beamformer 204 may configure the beamformer 204 to transmit the M-NDP 218 in accordance with the M-NDP format 222. For example, the apparatus may configure the access point to transmit one or more portions of the manipulated NDP in accordance with each of the following group: beamforming or no beamforming; a number of active transmit chains; a duration of the symbols of 1 times duration, 2 times duration, or 4 times duration of a legacy duration of 3.2 μs; and, a transmit power, wherein the transmit power may be different than other portions of the manipulated NDP.

The method 400 continues at operation 410 with encoding a trigger frame comprising resource allocations for one or more stations. For example, an apparatus of the beamformer 204 may encode TF 220. The TF 220 may include a resource allocation 224 for beamformees 206 to transmit feedback frames.

The method 400 continues at operation 412 with configuring the access point to transmit the trigger frame. For example an apparatus of the beamformer 204 may configure the beamformer 204 to transmit the TF 220.

The method 400 continues at operation 414 with decoding beamforming feedback frames from the one or more stations. The beamforming feedback frames are to be received by the access point in accordance with the resource allocations, and the beamforming feedback frames are to comprise feedback for the manipulated NDP frame. For example, an apparatus of the beamformer 204 may decode the beamforming feedback frames 210. In some embodiments, the method 400 may include multiple operations 406 and 408 for transmitting multiple manipulated NDP frames. In some embodiments, the method 400 may include multiple operations 410, 412, and 414, where multiple TF may be transmitted to accommodate more stations to send the feedback frame based on the same manipulated NDP frame. The access point may update which channels to send and/or receive packets on for one or more of the stations based on the received feedback frame.

FIG. 5 illustrates a method 500 of sounding using manipulated NDP in accordance with some embodiments. The method 500 may begin with operation 502 with decoding a NDP-A frame. The NDP-A frame may be encoded with a M-NDP format, where the M-NDP format indicates how one or more sounding elements of the M-NDP are to he transmitted. For example, an apparatus of a beamformee 206 may decode the NDP-A 216 with the M-NDP format 222.

The method 500 may continue at operation 504 with decoding a manipulated NDP frame. For example, an apparatus of a beamformee 206 may decode the M-NDP 218. The apparatus may decode the M-NDP frame based on the M-NDP format 222.

The method 500 may continue at operation 506 with determining feedback for the manipulated NDP frame. For example, an apparatus of the beamformees 206 may determine a beamforming feedback frame after receiving the M-NDP 218, The beamforming feedback frame may include feedback for multiple manipulated portions or sounding elements 316 and/or multiple M-NDPs 218. The determination of the feedback for the M-NDP frame may depend on the M-NDP format (e.g., 222 of FIG. 2) in that the M-NDP format will indicate how the M-NDP frame was transmitted by the transmitter of the M-NDP frame.

The method 500 may continue at operation 508 with decoding a trigger frame comprising a resource allocation the station. For example, an apparatus of the beamformees 206 may decode TF 220 that may comprise a resource allocation 224. In some embodiments, the resource allocation 224 may be included in the NDP-A, and the NDP-A may act as the TF with no operation 508 not being performed.

The method 500 may continue at operation 510 with encoding a feedback frame comprising the determined feedback of the manipulated NDP frame. For example, an apparatus of the beamformee 206.1 may encode the beamforming feedback frame 210.1.

The method 500 may continue at operation 512 with configuring the station to transmit the feedback frame in accordance with the resource allocation. For example, an apparatus of the beamformee 206.1 may configure the beamformee 206.1 to transmit the feedback frame 210.1, which may be in accordance with a resource allocation indicated in the resource allocation 224.

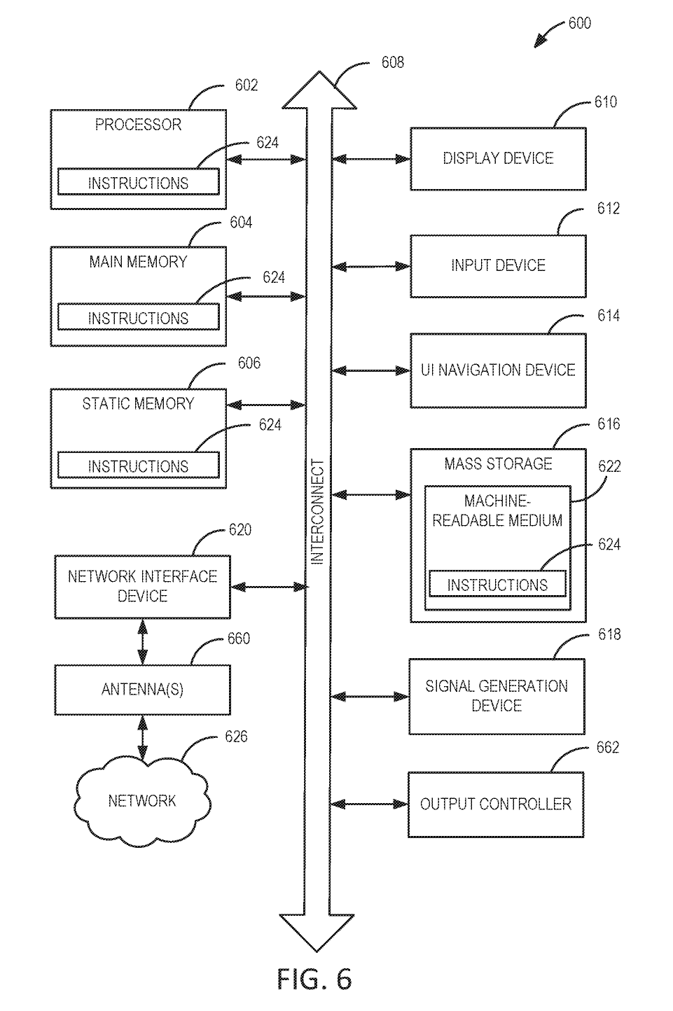

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a master station 102, HE station 104, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 1100 may further include a display unit 1110, an alphanumeric input device 1112. (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1116, a signal generation device 1118 (e.g., a speaker), a network interface device 1120, and one or more sensors 1121, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.). In some embodiments the processor 1102 and/or instructions 1124 may comprise processing circuitry.

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine readable media.

While the machine readable medium 1122 is illustrated as a single medium, the term “machine readable medium” may include a single medium or multiple media (e.g., a centralized or distributed database, and/or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 1124 may further be transmitted or received over a communications network 1126 using a transmission medium via the network interface device 1120 utilizing any one of a number of transfer protocols (e.g., frame relay, internee protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MEMO), or multiple-input single-output (MISO) techniques. In some examples, the network interface device 1120 may wirelessly communicate using Multiple User MIMO techniques. The term “transmission medium” shall be taken to include any intangible medium that is capable of storing, encoding or carrying instructions for execution by the machine 1100, and includes digital or analog communications signals or other intangible medium to facilitate communication of such software.

The following examples pertain to further embodiments. Specifics in the examples may be used in one or more embodiments.

Example 1 is an apparatus of a wireless device including memory and processing circuitry coupled to the memory, the processing circuitry configured to: encode a null data packet (NDP) announcement (NDP-A) frame, where the NDP-A frame is to he encoded with a manipulated NDP (M-NDP) format, and where the M-NDP format indicates how one or more sounding elements of the M-NDP are to be transmitted, configure the wireless device to transmit the NDP-A frame, encode the M-NDP frame, configure the wireless device to transmit the M-NDP frame in accordance with the M-NDP format, encode a trigger frame including resource allocations for one or more stations, configure the wireless device to transmit the trigger frame, and decode beamforming feedback frames from the one or more stations, where the beamforming feedback frames are to he received by the wireless device in accordance with the resource allocations, and where the beamforming feedback frames are to comprise feedback based on the M-NDP frame.

In Example 2, the subject matter of Example 1 can optionally include where the M-NDP format indicates for each of the one or more sounding elements of the M-NDP one or more of the following group: beamforming or no beamforming; a beamforming type; a number of active transmit chains; a duration of the symbols of 1 times duration, 2 times duration, or 4 times duration of a legacy duration of 3.2 μs; a modulation and coding scheme; and, a transmit power, where the transmit power may be different than other portions of the one or more portions.

In Example 3, the subject matter of Examples 1 or 2 can optionally include where the M-NDP format further indicates a report type for each of the sounding elements of the one or more sounding elements to be generated by the one or more stations.

In Example 4, the subject matter of Example 2 can optionally include where the processing circuitry is further configured to: encode a high-efficiency signal A (HE-SIG-A) subfield of the M-NDP with an indication of how the one or more portions of the M-NDP are to be transmitted.

In Example 5, the subject matter of Example 2 can optionally include where the processing circuitry is further configured to: encode a frame with the M-NDP format, and configure the wireless device to transmit the frame before the M-NDP.

In Example 6, the subject matter of Example 2 can optionally include where each of the one or more sounding elements comprise one or more high-efficiency (HE) long-training field (HE-LTFs) preceded by a HE short-training fields (HE-STFs).

In Example 7, the subject matter of Example 2 can optionally include where the one or more sounding elements are separated in time by one from the following group: a zero separation, a pre-defined separation, and a short inter-frame separation (SIFS).

In Example 8, the subject matter of Example 2 can optionally include where the beamforming feedback frames are to comprise feedback based on the M-NDP frame and based on a report type.

In Example 9, the subject matter of any of Examples 1-8 can optionally include where the processing circuitry is further configured to: encode one or more additional M-NDP frames, and configure the wireless device to transmit the one or more additional M-NDP frames after the M-NDP frame.

In Example 10, the subject matter of Example 9 can optionally include where the processing circuitry is further configured to: configure the wireless device to transmit the one or more additional M-NDP frames after the M-NDP frame, where the one or more additional M-NDP frames are to be transmitted in accordance with one from the following group: continuously with no separation between the M-NDP frames, a pre-defined delimiter between the M-NDP frames, and a short inter-frame separation (SIFS) between the M-NDP frames.

In Example 11, the subject matter of any of Examples 1-10 can optionally include where the processing circuitry is further configured to: encode the M-NDP frame to comprise a legacy short-training field (L-STF), a legacy long-training field (L-LTF), a legacy signal field (L-SIG), a very high-efficiency signal A field (HE-SIG-A), and one or more pairs of HE short-training fields (HE-STFs) and one or more high-efficiency throughput long-training fields (HE-LTFs), and configure the wireless device to transmit the M-NDP frame, where each of the HE-LTFs are to be transmitted in accordance with the M-NDP format.

In Example 12, the subject matter of any of Examples 1-11 can optionally include where the processing circuitry is further configured to: configure the wireless device to transmit the M-NDP frame on a first channel, where the beamforming feedback frames comprise beamforming feedback for two or more sub-channels of the first channel.

In Example 13, the subject matter of any of Examples 1-12 can optionally include where the processing circuitry is further configured to: determine a channel to transmit to at least one of the one or more stations based on the beamforming feedback frames, and configure the wireless device to transmit a second frame on the channel.

In Example 14, the subject matter of any of Examples 11-13 can optionally include where the processing circuitry is further configured to: encode a second trigger frame including additional resource allocations for one or more additional stations, configure the wireless device to transmit the second trigger frame, and decode additional beamforming feedback frames from the one or more additional stations, where the additional beamforming feedback frames are to be received by the wireless device in accordance with the additional resource allocations, and where the beamforming feedback frames are to comprise feedback based on the M-NDP frame.

In Example 15, the subject matter of any of Examples 1-14 can optionally include where the wireless device and the one or more stations are each at least one from the following group: a high-efficiency wireless local-area network (HEW) station, a HEW access point, a master station, an Institute of Electrical and Electronic Engineers (IEEE) 802.11ax access point, an access gateway, and an IEEE 802.11ax station.

In Example 16, the subject matter of any of Examples 1-15 can optionally include transceiver circuitry coupled to the memory.

In Example 17, the subject matter of Example 14 can optionally include one or more antennas coupled to the transceiver circuitry.

Example 18 is a non-transitory computer-readable storage medium that stores instructions for execution by one or more processors, the instructions to configure the one or more processors to cause a wireless device to: encode a null data packet (NDP) announcement (NDP-A) frame, where the NDP-A frame is to be encoded with a manipulated NDP (M-NDP) format, and where the M-NDP format indicates how one or more sounding elements of the M-NDP are to be transmitted, configure the wireless device to transmit the NDP-A frame, encode the M-NDP frame, configure the wireless device to transmit the M-NDP frame in accordance with the M-NDP format, encode a trigger frame including resource allocations for one or more stations, configure the wireless device to transmit the trigger frame, and decode beamforming feedback frames from the one or more stations, where the beamforming feedback frames are to be received by the wireless device in accordance with the resource allocations, and where the beamforming feedback frames are to comprise feedback based on the M-NDP frame.

In Example 19, the subject matter of Example 18 can optionally include where the M-NDP format indicates for each of the one or more sounding elements of the M-NDP one or more of the following group: beamforming or no beamforming; a beamforming type; a number of active transmit chains; a duration of the symbols of 1 times duration, 2 times duration, or 4 times duration of a legacy duration of 3.2 μs; a modulation and coding scheme; and, a transmit power, where the transmit power may be different than other portions of the one or more portions.

In Example 20, the subject matter of Example 18 can optionally include where the one or more sounding elements are to be separated in time by one from the following group: a zero separation, a pre-defined separation, and a short inter-frame separation (RFS),

Example 21 is an apparatus of a station including memory and processing circuitry coupled to the memory, the processing circuitry configured to: decode a null data packet (NDP) announcement (NDP-A) frame, where the NDP-A frame is encoded with a manipulated NDP (M-NDP) format, and where the M-NDP format indicates how one or more sounding elements of the M-NDP are to be transmitted, determine feedback for the M-NDP frame, decode a trigger frame including a resource allocation for the station, encode a feedback frame including the determined feedback of the M-NDP frame, and configure the station to transmit the feedback frame in accordance with the resource allocation.

In Example 22, the subject matter of Example 21 can optionally include where the M-NDP format indicates for each of the one or more sounding elements of the M-NDP one or more of the following group: beamforming or no beamforming; a beamforming type; a number of active transmit chains; a duration of the symbols of 1 times duration, 2 times duration, or 4 times duration of a legacy duration of 3.2 μs; a modulation and coding scheme; and, a transmit power, where the transmit power may be different than other portions of the one or more portions.

In Example 23, the subject matter of Example 21 can optionally include transceiver circuitry coupled to the memory; and, one or more antennas coupled to the transceiver circuitry.

Example 24 is a method performed by a wireless device, the method including: encoding a null data packet (NDP) announcement (NDP-A) frame, where the NDP-A frame is to be encoded with a manipulated NDP (M-NDP) format, and where the M-NDP format indicates how one or more sounding elements of the M-NDP are to be transmitted, configuring the wireless device to transmit the NDP-A frame, encoding the M-NDP frame, configuring the wireless device to transmit the M-NDP frame in accordance with the M-NDP format, encoding a trigger frame including resource allocations for one or more stations, configuring the wireless device to transmit the trigger frame, and decoding beamforming feedback frames from the one or more stations, where the beamforming feedback frames are to be received by the wireless device in accordance with the resource allocations, and where the beamforming feedback frames are to comprise feedback based on the M-NDP frame.

In Example 24, the subject matter of Example 24 can optionally include where the M-NDP format indicates for each of the one or more sounding elements of the M-NDP one or more of the following group: beamforming or no beamforming; a beamforming type; a number of active transmit chains; a duration of the symbols of 1 times duration, 2 times duration, or 4 times duration of a legacy duration of 3.2 μs; a modulation and coding scheme; and, a transmit power, where the transmit power may be different than other portions of the one or more portions.

Example 26 is an apparatus of a wireless device including: means for encoding a null data packet (NDP) announcement (NDP-A) frame, where the NDP-A frame is to be encoded with a manipulated NDP (M-NDP) format, and where the M-NDP format indicates how one or more sounding elements of the M-NDP are to be transmitted, means for configuring the wireless device to transmit the NDP-A frame, means for encoding the M-NDP frame, means for configuring the wireless device to transmit the M-NDP frame in accordance with the M-NDP format, means for encoding a trigger frame including resource allocations for one or more stations, means for configuring the wireless device to transmit the trigger frame, and means for decoding beamforming feedback frames from the one or more stations, where the beamforming feedback frames are to be received by the wireless device in accordance with the resource allocations, and where the beamforming feedback frames are to comprise feedback based on the M-NDP frame.

In Example 27, the subject matter of Example 26 can optionally include where the M-NDP format indicates for each of the one or more sounding elements of the M-NDP one or more of the following group: beamforming or no beamforming; a beamforming type; a number of active transmit chains; a duration of the symbols of 1 times duration, 2 times duration, or 4 times duration of a legacy duration of 3.2 μs; a modulation and coding scheme; and, a transmit power, where the transmit power may be different than other portions of the one or more portions.

In Example 28, the subject matter of Examples 26 or 27 can optionally include where the M-NDP format further indicates a report type for each of the sounding elements of the one or more sounding elements to be generated by the one or more stations.

In Example 29, the subject matter of Example 26 can optionally include means for encoding a high-efficiency signal A (HE-SIG-A) subfield of the M-NDP with an indication of how the one or more portions of the M-NDP are to be transmitted.

in Example 30, the subject matter of Example 26 can optionally include means for encoding a frame with the M-NDP format, and means for configuring the wireless device to transmit the frame before the M-NDP.

In Example 31, the subject matter of Example 26 can optionally include where each of the one or more sounding elements comprise one or more high-efficiency (HE) long-training field (HE-LTFs) preceded by a HE short-training fields (HE-STFs).

in Example 32, the subject matter of Example 26 can optionally include where the one or more sounding elements are separated in time by one from the following group: a zero separation, a pre-defined separation, and a short inter-frame separation (SIFS).

In Example 33, the subject matter of Example 27 can optionally include where the beamforming feedback frames are to comprise feedback based on the M-NDP frame and based on a report type.

In Example 34, the subject matter of any of Examples 26-33 can optionally include means for encoding one or more additional M-NDP frames, and means for configuring the wireless device to transmit the one or more additional M-NDP frames after the M-NDP frame,

In Example 35, the subject matter of Example 34 can optionally include means for configuring the wireless device to transmit the one or more additional M-NDP frames after the M-NDP frame, where the one or more additional M-NDP frames are to be transmitted in accordance with one from the following group: continuously with no separation between the M-NDP frames, a pre-defined delimiter between the M-NDP frames, and a short inter-frame separation (SIFS) between the M-NDP frames.

In Example 36, the subject matter of any of Examples 26-35 can optionally include means for encoding the M-NDP frame to comprise a legacy short-training field (L-STF), a legacy long-training field (L-LTF), a legacy signal field (L-SIG), a very high-efficiency signal A field (HE-SIG-A), and one or more pairs of HE short-training fields (HE-STFs) and one or more high-efficiency throughput long-training fields (HE-LTFs), and means for configuring the wireless device to transmit the M-NDP frame, where each of the HE-LTFs are to be transmitted in accordance with the M-NDP format.

In Example 37, the subject matter of any of Examples 26-36 can optionally include means for configuring the wireless device to transmit the M-NDP frame on a first channel, where the beamforming feedback frames comprise beamforming feedback for two or more sub-channels of the first channel.

In Example 38, the subject matter of any of Examples 26-37 can optionally include means for determining a channel to transmit to at least one of the one or more stations based on the beamforming feedback frames, and means for configuring the wireless device to transmit a second frame on the channel.

In Example 39, the subject matter of any of Examples 26-38 can optionally include means for encoding a second trigger frame including additional resource allocations for one or more additional stations, means for configuring the wireless device to transmit the second trigger frame, and means for decoding additional beamforming feedback frames from the one or more additional stations, where the additional beamforming feedback frames are to be received by the wireless device in accordance with the additional resource allocations, and where the beamforming feedback frames are to comprise feedback based on the M-NDP frame,

In Example 40, the subject matter of any of Examples 26-39 can optionally include where the wireless device and the one or more stations are each at least one from the following group: a high-efficiency wireless local-area network (HEW) station, a HEW access point, a master station, an Institute of Electrical and Electronic Engineers (IEEE) 802.11ax access point, an access gateway, and an IEEE 802.11ax station.

In Example 41, the subject matter of any of Examples 26-40 can optionally include means for processing received radio signals and radio signals to be transmitted,

In Example 42, the subject matter of Example 41 can optionally include means for transmitting and receiving radio signals.

Example 43 is a non-transitory computer-readable storage medium that stores instructions for execution by one or more processors, the instructions to configure the one or more processors to cause a station to: decode a null data packet (NDP) announcement (NDP-A) frame, where the NDP-A frame is encoded with a manipulated NDP (M-NDP) format, and where the M-NDP format indicates how one or more sounding elements of the M-NDP are to be transmitted, determine feedback for the M-NDP frame, decode a trigger frame including a resource allocation for the station, encode a feedback frame including the determined feedback of the M-NDP frame, and configure the station to transmit the feedback frame in accordance with the resource allocation.

In Example 44, the subject matter of Example 43 can optionally include where the M-NDP format indicates for each of the one or more sounding elements of the M-NDP one or more of the following group: beamforming or no beamforming; a beamforming type; a number of active transmit chains; a duration of the symbols of 1 times duration, 2 times duration, or 4 times duration of a legacy duration of 3.2 μs; a modulation and coding scheme; and, a transmit power, where the transmit power may be different than other portions of the one or more portions.

Example 45 is a method performed by a station, the method including: decoding a null data packet (NDP) announcement (NDP-A) frame, where the NDP-A frame is encoded with a manipulated NDP (M-NDP) format, and where the M-NDP format indicates how one or more sounding elements of the M-NDP are to be transmitted, determining feedback for the M-NDP frame, decoding a trigger frame including a resource allocation for the station, encoding a feedback frame including the determined feedback of the M-NDP frame, and configuring the station to transmit the feedback frame in accordance with the resource allocation.

In Example 46, the subject matter of Example 43 can optionally include where the M-NDP format indicates for each of the one or more sounding elements of the M-NDP one or more of the following group: beamforming or no beamforming; a beamforming type; a number of active transmit chains; a duration of the symbols of 1 times duration, 2 times duration, or 4 times duration of a legacy duration of 3.2 μs; a modulation and coding scheme; and, a transmit power, where the transmit power may be different than other portions of the one or more portions.

Example 47 is an apparatus of a station, the apparatus including: means for decoding a null data packet (NDP) announcement (NDP-A) frame, where the NDP-A frame is encoded with a manipulated NDP (M-NDP) format, and where the M-NDP format indicates how one or more sounding elements of the M-NDP are to be transmitted, means for determining feedback for the M-NDP frame, means for decoding a trigger frame including a resource allocation for the station, means for encoding a feedback frame including the determined feedback of the M-NDP frame, and means for configuring the station to transmit the feedback frame in accordance with the resource allocation.

In Example 48, the subject matter of Example 47 can optionally include where the M-NDP format indicates for each of the one or more sounding elements of the M-NDP one or more of the following group: beamforming or no beamforming; a beamforming type; a number of active transmit chains; a duration of the symbols of 1 times duration, 2 times duration, or 4 times duration of a legacy duration of 3.2 μs; a modulation and coding scheme; and, a transmit power, where the transmit power may be different than other portions of the one or more portions.

The Abstract is provided to comply with 37 C.F.R. Section 1.72(h) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a wireless device comprising memory and processing circuitry coupled to the memory, the processing circuitry configured to:
encode a null data packet (NDP) announcement (NDP-A) frame, wherein the NDP-A frame is to be encoded with a manipulated NDP (M-NDP) format, and wherein the M-NDP format indicates how one or more sounding elements of the M-NDP are to be transmitted;
configure the wireless device to transmit the NDP-A frame;
encode the M-NDP frame;
configure the wireless device to transmit the M-NDP frame in accordance with the M-NDP format;
encode a trigger frame comprising resource allocations for one or more stations;
configure the wireless device to transmit the trigger frame; and
decode beamforming feedback frames from the one or more stations, wherein the beamforming feedback frames are to be received by the wireless device in accordance with the resource allocations, and wherein the beamforming feedback frames are to comprise feedback based on the M-NDP frame.

2. The apparatus of claim 1, wherein the M-NDP format indicates for each of the one or more sounding elements of the M-NDP one or more of the following group: beamforming or no beamforming; a beamforming type; a number of active transmit chains; a duration of the symbols of 1 times duration, 2 times duration, or 4 times duration of a legacy duration of 3.2 μs; a modulation and coding scheme; and, a transmit power, wherein the transmit power may be different than other portions of the one or more portions.

3. The apparatus of claim 2, wherein the M-NDP format further indicates a report type for each of the sounding elements of the one or more sounding elements to be generated by the one or more stations.

4. The apparatus of claim 2, wherein the processing circuitry is further configured to:
encode a high-efficiency signal A (HE-SIG-A) subfield of the M-NDP with an indication of how the one or more portions of the M-NDP are to be transmitted.

5. The apparatus of claim 2, wherein the processing circuitry is further configured to:
encode a frame with the M-NDP format; and
configure the wireless device to transmit the frame before the M-NDP.

6. The apparatus of claim 2, wherein each of the one or more sounding elements comprise one or more high-efficiency (HE) long-training field (HE-LTFs) preceded by a HE short-training fields (HE-STFs).

7. The apparatus of claim 2, wherein the one or more sounding elements are separated in time by one from the following group: a zero separation, a pre-defined separation, and a short inter-frame separation (SIFS).

8. The apparatus of claim 2, wherein the beamforming feedback frames are to comprise feedback based on the M-NDP frame and based on a report type.

9. The apparatus of claim 1, wherein the processing circuitry is further configured to:
encode one or more additional M-NDP frames; and
configure the wireless device to transmit the one or more additional M-NDP frames after the M-NDP frame.

10. The apparatus of claim 9, wherein the processing circuitry is further configured to:
configure the wireless device to transmit the one or more additional M-NDP frames after the M-NDP frame, wherein the one or more additional M-NDP frames are to be transmitted in accordance with one from the following group: continuously with no separation between the M-NDP frames, a pre-defined delimiter between the M-NDP frames, and a short inter-frame separation (SIFS) between the M-NDP frames.

11. The apparatus of claim 1, wherein the processing circuitry is further configured to:
encode the M-NDP frame to comprise a legacy short-training field (L-STF), a legacy long-training field (L-LTF), a legacy signal field (L-SIG), a very high-efficiency signal A field (HE-SIG-A), and one or more pairs of HE short-training fields (HE-STFs) and one or more high-efficiency throughput long-training fields (HE-LTFs); and
configure the wireless device to transmit the M-NDP frame, wherein each of the HE-LTFs are to be transmitted in accordance with the M-NDP format.

12. The apparatus of claim 1, wherein the processing circuitry is further configured to:
configure the wireless device to transmit the M-NDP frame on a first channel, wherein the beamforming feedback frames comprise beamforming feedback for two or more sub-channels of the first channel.

13. The apparatus of claim 1, wherein the processing circuitry is further configured to:
determine a channel to transmit to at least one of the one or more stations based on the beamforming feedback frames; and
configure the wireless device to transmit a second frame on the channel.

14. The apparatus of claim 1, wherein the processing circuitry is further configured to:
encode a second trigger frame comprising additional resource allocations for one or more additional stations;
configure the wireless device to transmit the second trigger frame; and
decode additional beamforming feedback frames from the one or more additional stations, wherein the additional beamforming, feedback frames are to be received by the wireless device in accordance with the additional resource allocations, and wherein the beamforming feedback frames are to comprise feedback based on the M-NDP frame.

15. The apparatus of claim 1, wherein the wireless device and the one or more stations are each at least one from the following group: a high-efficiency wireless local-area network (HEW) station, a HEW access point, a master station, an Institute of Electrical and Electronic Engineers FEE) 802.11ax access point, an access gateway, and an IEEE 802.11ax station.

16. The apparatus of claim 1, further comprising transceiver circuitry coupled to the memory.

17. The apparatus of claim 14, further comprising: one or more ante as coupled to the transceiver circuitry.

18. A non-transitory computer-readable storage medium that stores instructions for execution by one or more processors, the instructions to configure the one or more processors to cause a wireless device to:
encode a null data packet (NDP) announcement (NDP-A) frame, wherein the NDP-A frame is to be encoded with a manipulated NDP (M-NDP) format, and wherein the M-NDP format indicates how one or more sounding elements of the 111-NDP are to be transmitted;
configure the wireless device to transmit the NDP-A frame;
encode the M-NDP frame;
configure the wireless device to transmit the M-NDP frame in accordance with the M-NDP format;
encode a trigger frame comprising resource allocations for one or more stations;
configure the wireless device to transmit the trigger frame; and
decode beamforming feedback frames from the one or more stations, wherein the beamforming feedback frames are to be received by the wireless device in accordance with the resource allocations, and wherein the beamforming feedback frames are to comprise feedback based on the M-NDP frame.

19. The non-transitory computer-readable storage medium of claim 18, wherein the M-NDP format indicates for each of the one or more sounding elements of the M-NDP one or more of the following group: beamforming or no beamforming; a beamforming type; a number of active transmit chains; a duration of the symbols of 1 times duration, 2 times duration, or 4 times duration of a legacy duration of 3.2 μs; a modulation and coding scheme; and, a transmit power, wherein the transmit power may be different than other portions of the one or more portions.

20. The non-transitory computer-readable storage medium of claim 18, wherein the one or more sounding elements are to be separated in time by one from the following group: a zero separation; a pre-defined separation, and a short inter-frame separation (SIFS).

21. An apparatus of a station comprising memory and processing circuitry coupled to the memory, the processing circuitry configured to:
decode a null data packet (NDP) announcement (NDP-A) frame, wherein the NDP-A frame is encoded with a manipulated NDP (M-NDP) format, and wherein the M-NDP format indicates how one or more sounding elements of the M-NDP are to be transmitted;
determine feedback for the M-NDP frame;
decode a trigger frame comprising a resource allocation for the station;
encode a feedback frame comprising the determined feedback of the M-NDP frame; and
configure the station to transmit the feedback frame in accordance with the resource allocation.

22. The apparatus of claim 21, wherein the M-NDP format indicates for each of the one or more sounding elements of the M-NDP one or more of the following group: beamforming or no beamforming; a beamforming type; a number of active transmit chains; a duration of the symbols of 1 times duration, 2 times duration, or 4 times duration of a legacy duration of 3.2 μs; a modulation and coding scheme; and, a transmit power, wherein the transmit power may be different than other portions of the one or more portions.

23. The apparatus of claim 21, further comprising: transceiver circuitry coupled to the memory; and, one or more antennas coupled to the transceiver circuitry.

24. A method performed by a wireless device, the method comprising:
encoding a null data packet (NDP) announcement (NDP-A) frame, wherein the NDP-:A frame is to be encoded with a manipulated NDP (M-NDP) format, and wherein the M-NDP format indicates how one or more sounding elements of the M-NDP are to be transmitted;
configuring the wireless device to transmit the NDP-A frame;
encoding the M-NDP frame;
configuring the wireless device to transmit the M-NDP frame in accordance with the M-NDP format;
encoding a trigger frame comprising resource allocations for one or more stations;
configuring the wireless device to transmit the trigger frame; and
decoding beamforming feedback frames from the one or more stations, wherein the beamforming feedback frames are to be received by the wireless device in accordance with the resource allocations, and wherein the beamforming feedback frames are to comprise feedback based on the M-NDP frame.

25. The method of claim 24, wherein the M-NDP format indicates for each of the one or more sounding elements of the M-NDP one or more of the following group: beamforming or no beamforming; a beamforming type; a number of active transmit chains; a duration of the symbols of 1 times duration, 2 times duration, or 4 times duration of a legacy duration of 3.2 μs; a modulation and coding scheme; and, a transmit power, wherein the transmit power may he different than other portions of the one or more portions.
